(19) United States
(12) Patent Application Publication
(10) Pub. No.: US 2026/0031054 A1
(43) Pub. Date: Jan. 29, 2026

(54) DISPLAY DEVICE, AND METHOD OF OPERATING A DISPLAY DEVICE

(71) Applicant: Samsung Display Co., Ltd., Yongin-si (KR)

(72) Inventor: KYUNG-HUN LEE, Yongin-si (KR)

(21) Appl. No.: 19/186,204

(22) Filed: Apr. 22, 2025

(30) Foreign Application Priority Data
Jul. 24, 2024 (KR) 10-2024-0097870

(51) Int. Cl. G09G 3/3275; G09G 3/32; G09G 3/3266

(52) U.S. Cl. CPC G09G 3/3275; G09G 3/32; G09G 3/3266; G09G 2310/0267; G09G 2310/0275; G09G 2330/021

(57) ABSTRACT

A display device includes a display panel including pixels, a scan driver configured to provide scan signals to the pixels, a data driver configured to provide data signals to the pixels, a controller configured to control the scan driver and the data driver, a power board configured to generate a power supply voltage for the pixels, and a scaler configured to receive input image data from a host processor, to convert a data format of the input image data, to provide converted input image data to the controller, to determine a luminance mode of the display device, and to control the power board to adjust the power supply voltage according to the luminance mode.

### CROSS-REFERENCE TO RELATED APPLICATION

The present application claims priority to, and the benefit of, Korean Patent Application No. 10-2024-0097870, filed on Jul. 24, 2024, in the Korean Intellectual Property Office, the entire disclosure of which is incorporated herein by reference.

### BACKGROUND

### 1. Field

Embodiments of the present disclosure relate to a display device that adjusts a power supply voltage, and a method of operating the display device.

### 2. Description of the Related Art

In general, a control board (e.g., a controller printed circuit board assembly) of a display device may include a controller that controls an operation of the display device, and a power supply circuit that generates power supply voltages for the display device based on an external input voltage received from a power board external to the control board. For example, the power supply circuit of the control board may be controlled by the controller to generate a power supply voltage for a plurality of pixels of the display device.

Recently, to reduce power consumption, a display device has been developed in which the control board does not include the power supply circuit, and the power board external to the control board generates the power supply voltage for the plurality of pixels. In this case, the power board may directly provide the power supply voltage to the plurality of pixels. However, in the display device in which the power board directly provides the power supply voltage to the plurality of pixels, there may be a problem in that the controller of the control board cannot control the power supply voltage for the plurality of pixels.

### SUMMARY

Some embodiments provide a display device capable of reducing power consumption by adjusting a power supply voltage generated by a power board.

Some embodiments provide a method of operating a display device capable of reducing power consumption by adjusting a power supply voltage generated by a power board.

According to embodiments, there is provided a display device including a display panel including pixels, a scan driver configured to provide scan signals to the pixels, a data driver configured to provide data signals to the pixels, a controller configured to control the scan driver and the data driver, a power board configured to generate a power supply voltage for the pixels, and a scaler configured to receive input image data from a host processor, to convert a data format of the input image data, to provide converted input image data to the controller, to determine a luminance mode of the display device, and to control the power board to adjust the power supply voltage according to the luminance mode.

A voltage level of the power supply voltage may increase as a maximum luminance of the luminance mode increases.

The scaler may include a mode-to-power supply voltage lookup table configured to store voltage levels of the power supply voltage respectively corresponding to luminance modes, and a power supply voltage determiner configured to determine one of the voltage levels of the power supply voltage corresponding to the luminance mode using the mode-to-power supply voltage lookup table.

The controller may include a mode-to-power supply voltage lookup table configured to store voltage levels of the power supply voltage respectively corresponding to luminance modes, and a power supply voltage determiner configured to receive a mode signal indicating the luminance mode from the scaler, and determine one of the voltage levels of the power supply voltage corresponding to the luminance mode using the mode-to-power supply voltage lookup table.

The controller may be configured to provide a power supply voltage level signal indicating the one of the voltage levels of the power supply voltage to the scaler, wherein the scaler is configured to control the power board in response to the power supply voltage level signal such that the power supply voltage has the one of the voltage levels.

The power supply voltage may be determined based on the luminance mode and a panel efficiency of the display panel.

A voltage level of the power supply voltage may increase as a maximum luminance of the luminance mode increases, and may decrease as the panel efficiency increases.

The controller may include a mode-to-power supply voltage lookup table configured to store voltage levels of the power supply voltage respectively corresponding to luminance modes, a panel efficiency bank configured to store panel efficiency information indicating the panel efficiency, a panel efficiency-to-change amount lookup table configured to store power supply voltage level change amounts respectively corresponding to panel efficiencies, and a power supply voltage determiner configured to receive a mode signal indicating the luminance mode from the scaler, determine an intermediate voltage level of the power supply voltage corresponding to the luminance mode using the mode-to-power supply voltage lookup table, receive the panel efficiency information from the panel efficiency bank, receive one of the power supply voltage level change amounts corresponding to the panel efficiency information from the panel efficiency-to-change amount lookup table, and determine a final voltage level of the power supply voltage by adjusting the intermediate voltage level by the one of the power supply voltage level change amounts.

The controller may be configured to provide a power supply voltage level signal, which indicates the final voltage level, to the scaler, wherein the scaler is configured to control the power board in response to the power supply voltage level signal such that the power supply voltage has the final voltage level.

The controller may include a panel efficiency bank configured to store panel efficiency information indicating the panel efficiency, and wherein the scaler includes a panel efficiency-to-change amount lookup table configured to store power supply voltage level change amounts respectively corresponding to panel efficiencies, a mode-to-power supply voltage lookup table configured to store voltage levels of the power supply voltage respectively corresponding to luminance modes, and a power supply voltage determiner configured to determine an intermediate voltage level of the power supply voltage corresponding to the luminance mode using the mode-to-power supply voltage lookup table, receive the panel efficiency information from the controller, receive a power supply voltage level change amount, which corresponds to the panel efficiency, from the panel efficiency-to-change amount lookup table, and determine a final voltage level of the power supply voltage by adjusting the intermediate voltage level by the power supply voltage level change amount.

The power supply voltage may be determined based on the luminance mode and a degradation amount of the display panel.

A voltage level of the power supply voltage may increase as a maximum luminance of the luminance mode increases, or as the degradation amount increases.

The controller may include a mode-to-power supply voltage lookup table configured to store voltage levels of the power supply voltage respectively corresponding to luminance modes, a degradation amount calculator configured to calculate the degradation amount by accumulating the converted input image data received from the scaler, a degradation amount-to-change amount lookup table configured to store power supply voltage level change amounts respectively corresponding to degradation amounts, and a power supply voltage determiner configured to receive a mode signal, which indicates the luminance mode, from the scaler, determine an intermediate voltage level of the power supply voltage corresponding to the luminance mode using the mode-to-power supply voltage lookup table, receive the degradation amount from the degradation amount calculator, receive a power supply voltage level change amount, which corresponds to the degradation amount, from the degradation amount-to-change amount lookup table, and determine a final voltage level of the power supply voltage by adjusting the intermediate voltage level by the power supply voltage level change amount.

The controller may be configured to provide a power supply voltage level signal, which indicates the final voltage level, to the scaler, wherein the scaler is configured to control the power board in response to the power supply voltage level signal such that the power supply voltage has the final voltage level.

The controller may include a degradation amount calculator configured to calculate the degradation amount by accumulating the converted input image data received from the scaler, wherein the scaler includes a mode-to-power supply voltage lookup table configured to store voltage levels of the power supply voltage respectively corresponding to luminance modes, a degradation amount-to-change amount lookup table configured to store power supply voltage level change amounts respectively corresponding to degradation amounts, and a power supply voltage determiner configured to determine an intermediate voltage level of the power supply voltage corresponding to the luminance mode using the mode-to-power supply voltage lookup table, receive the degradation amount from the controller, receive a power supply voltage level change amount, which corresponds to the degradation amount, from the degradation amount-to-change amount lookup table, and determine a final voltage level of the power supply voltage by adjusting the intermediate voltage level by the power supply voltage level change amount.

The power supply voltage may be determined based on the luminance mode, a panel efficiency of the display panel, and a degradation amount of the display panel.

According to embodiments, there is provided a method of operating a display device, the method including determining, by a scaler of the display device, a luminance mode of the display device, determining a power supply voltage according to the luminance mode, generating, by a power board of the display device, the power supply voltage determined according to the luminance mode, and displaying, by a display panel of the display device, an image based on the power supply voltage received from the power board.

A voltage level of the power supply voltage may increase as a maximum luminance of the luminance mode increases.

The method may further include storing panel efficiency information indicating a panel efficiency of the display panel, and adjusting a voltage level of the power supply voltage according to the panel efficiency.

The method may further include calculating a degradation amount of the display panel, and adjusting a voltage level of the power supply voltage according to the degradation amount.

According to embodiments, there is provided an electronic device including a display device including a display panel including pixels, a scan driver configured to provide scan signals to the pixels, a data driver configured to provide data signals to the pixels, a controller configured to control the scan driver and the data driver, a power board configured to generate a power supply voltage for the pixels, and a scaler configured to receive input image data from a host processor, to convert a data format of the input image data, to provide converted input image data to the controller, to determine a luminance mode of the display device, and to control the power board to adjust the power supply voltage according to the luminance mode.

The electronic device may include a smartphone, a television, a monitor, a tablet, an electric vehicle, a mobile phone, a tablet personal computer (PC), a mobile communication terminal, an electronic notebook, an electronic book, a portable multimedia player (PMP), a navigation device, an ultra-mobile PC (UMPC), a laptop computer, a billboard, an Internet of Things (IoT) device, a smartwatch, a watch phone, or a head-mounted display (HMD).

As described above, in a display device and a method of operating the display device according to embodiments, a scaler may control a power board to adjust a power supply voltage for a plurality of pixels according to a luminance mode of the display device. Accordingly, in the display device in which the power board external to a control board directly provides the power supply voltage to the plurality of pixels, a voltage level of the power supply voltage may be adjusted, and power consumption of the display device may be reduced.

### BRIEF DESCRIPTION OF THE DRAWINGS

Illustrative, non-limiting embodiments will be more clearly understood from the following detailed description in conjunction with the accompanying drawings.

FIG. 1 is a block diagram illustrating a display device according to embodiments.

FIG. 2 is a circuit diagram illustrating an example of a pixel included in a display device according to embodiments.

FIG. 3 is a diagram illustrating an example of a mode-power supply voltage lookup table included in a display device according to embodiments.

FIG. 4 is a flowchart illustrating a method of operating a display device according to embodiments.

FIG. 5 is a block diagram illustrating a display device according to embodiments.

FIG. 6 is a flowchart illustrating a method of operating a display device according to embodiments.

FIG. 7 is a block diagram illustrating a display device according to embodiments.

FIG. 8 is a diagram for describing an example of power supply voltages in display devices having different panel efficiencies.

FIG. 9 is a flowchart illustrating a method of operating a display device according to embodiments.

FIG. 10 is a block diagram illustrating a display device according to embodiments.

FIG. 11 is a flowchart illustrating a method of operating a display device according to embodiments.

FIG. 12 is a block diagram illustrating a display device according to embodiments.

FIG. 13 and FIG. 14 are diagrams for describing examples in which a power supply voltage is increased as a degradation amount of a display panel increases.

FIG. 15 is a flowchart illustrating a method of operating a display device according to embodiments.

FIG. 16 is a block diagram illustrating a display device according to embodiments.

FIG. 17 is a flowchart illustrating a method of operating a display device according to embodiments.

FIG. 18 is a block diagram illustrating a portion of a display device according to embodiments.

FIG. 19 is a block diagram illustrating a portion of a display device according to embodiments.

FIG. 20 is a block diagram illustrating an electronic device including a display device according to embodiments.

### DETAILED DESCRIPTION

Aspects of some embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The use of “can,” “may,” or “may not” in describing an embodiment corresponds to one or more embodiments of the present disclosure.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

In the drawings, the relative sizes of elements, layers, and regions may be exaggerated for clarity and/or descriptive purposes. In other words, because the sizes and thicknesses of elements in the drawings are arbitrarily illustrated for convenience of description, the disclosure is not limited thereto. Further, specific structural or functional descriptions disclosed herein are merely illustrative for the purpose of describing embodiments according to the concept of the present disclosure. Thus, embodiments disclosed herein should not be construed as limited to the illustrated shapes of elements, layers, or regions, but are to include deviations in shapes that result from, for instance, manufacturing.

It will be understood that when an element, layer, region, or component (e.g., an apparatus, a device, a circuit, a wire, an electrode, a terminal, a conductive film, etc.) is referred to as being “formed on,” “on,” “connected to,” or “(operatively, functionally, or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection.

For example, when a layer, region, or component is referred to as being “electrically connected” or “electrically coupled” to another layer, region, or component, it can be directly electrically connected or coupled to the other layer, region, and/or component or one or more intervening layers, regions, or components may be present. The one or more intervening components may include a switch, a transistor, a resistor, an inductor, a capacitor, a diode and/or the like. Accordingly, a connection is not limited to the connections illustrated in the drawings or the detailed description and may also include other types of connections. In describing embodiments, an expression of connection indicates electrical connection unless explicitly described to be direct connection, and “directly connected/directly coupled,” or “directly on,” refers to one component directly connecting or coupling another component, or being on another component, without an intermediate component. Meanwhile, other expressions describing relationships between components, such as “between,” “immediately between” or “adjacent to” and “directly adjacent to,” may be construed similarly. It will be understood that when an element or layer is referred to as being “between” two elements or layers, it can be the only element or layer between the two elements or layers, or one or more intervening elements or layers may also be present.

For the purposes of this disclosure, expressions such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XYY, YZ, and ZZ, or any variation thereof. Similarly, the expressions “at least one of A and B” and “at least one of A or B” may include A, B, or A and B. As used herein, “or” generally means “and/or,” and the term “and/or” includes any and all combinations of one or more of the associated listed items. For example, the expression “A and/or B” may include A, B, or A and B. Similarly, expressions such as “at least one of,” “a plurality of,” “one of,” and other prepositional phrases, when preceding a list of elements, modify the entire list of elements and do not modify the individual elements of the list. When “C to D” is stated, it means C or more and D or less, unless otherwise specified.

It will be understood that, although the terms “first,” “second,” “third,” etc., may be used herein to describe various elements, components, regions, layers and/or sections, these elements, components, regions, layers and/or sections should not be limited by these terms. These terms do not correspond to a particular order, position, or superiority, and are only used to distinguish one element, member, component, region, area, layer, section, or portion from another element, member, component, region, area, layer, section, or portion. Thus, a first element, component, region, layer or section described below could be termed a second element, component, region, layer or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

The terminology used herein is for the purpose of describing embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

When one or more embodiments may be implemented differently, a specific process order may be performed differently from the described order. For example, two consecutively described processes may be performed substantially at the same time or performed in an order opposite to the described order.

As used herein, the terms “substantially,” “about,” “approximately,” and similar terms are used as terms of approximation and not as terms of degree, and are intended to account for the inherent deviations in measured or calculated values that would be recognized by those of ordinary skill in the art. For example, “substantially” may include a range of +/−5% of a corresponding value. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value. Further, the use of “may” when describing embodiments of the present disclosure refers to “one or more embodiments of the present disclosure.” Furthermore, the expression “being the same” may mean “being substantially the same”. In other words, the expression “being the same” may include a range that can be tolerated by those of ordinary skill in the art. The other expressions may also be expressions from which “substantially” has been omitted.

In some embodiments well-known structures and devices may be described in the accompanying drawings in relation to one or more functional blocks (e.g., block diagrams), units, and/or modules to avoid unnecessarily obscuring various embodiments. Those skilled in the art will understand that such block, unit, and/or module are/is physically implemented by a logic circuit, an individual component, a microprocessor, a hard wire circuit, a memory element, a line connection, and other electronic circuits. This may be formed using a semiconductor-based manufacturing technique or other manufacturing techniques. The block, unit, and/or module implemented by a microprocessor or other similar hardware may be programmed and controlled using software to perform various functions discussed herein, optionally may be driven by firmware and/or software. In addition, each block, unit, and/or module may be implemented by dedicated hardware, or a combination of dedicated hardware that performs some functions and a processor (for example, one or more programmed microprocessors and related circuits) that performs a function different from those of the dedicated hardware. In addition, in some embodiments, the block, unit, and/or module may be physically separated into two or more interact individual blocks, units, and/or modules without departing from the scope of the present disclosure. In addition, in some embodiments, the block, unit and/or module may be physically combined into more complex blocks, units, and/or modules without departing from the scope of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

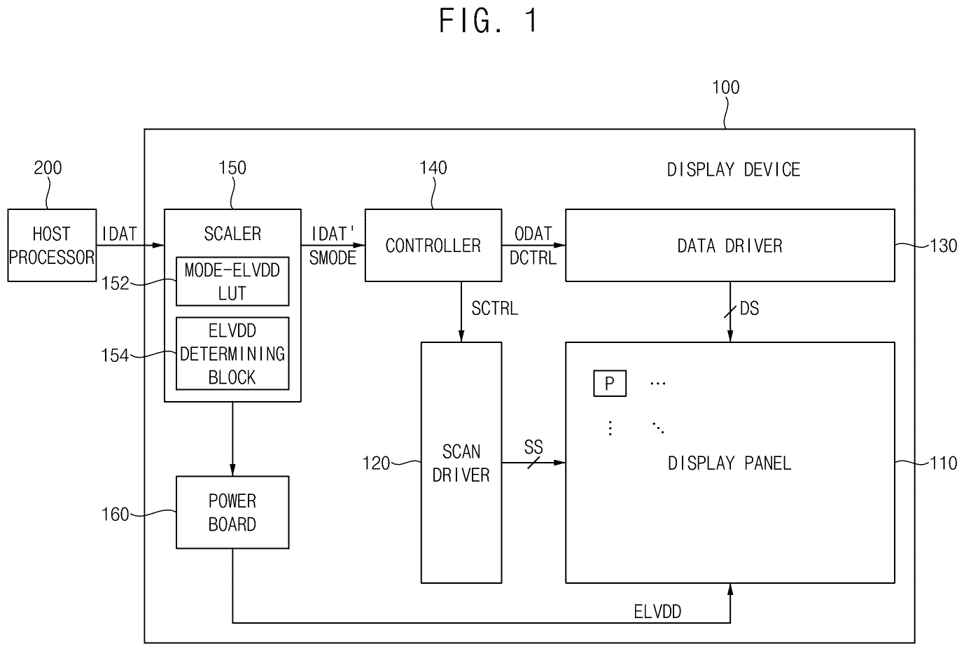

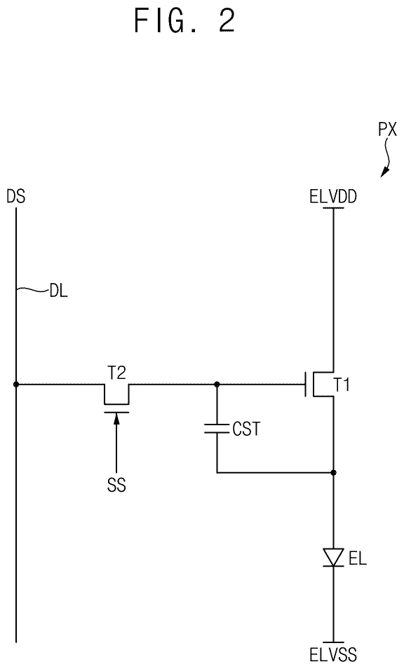

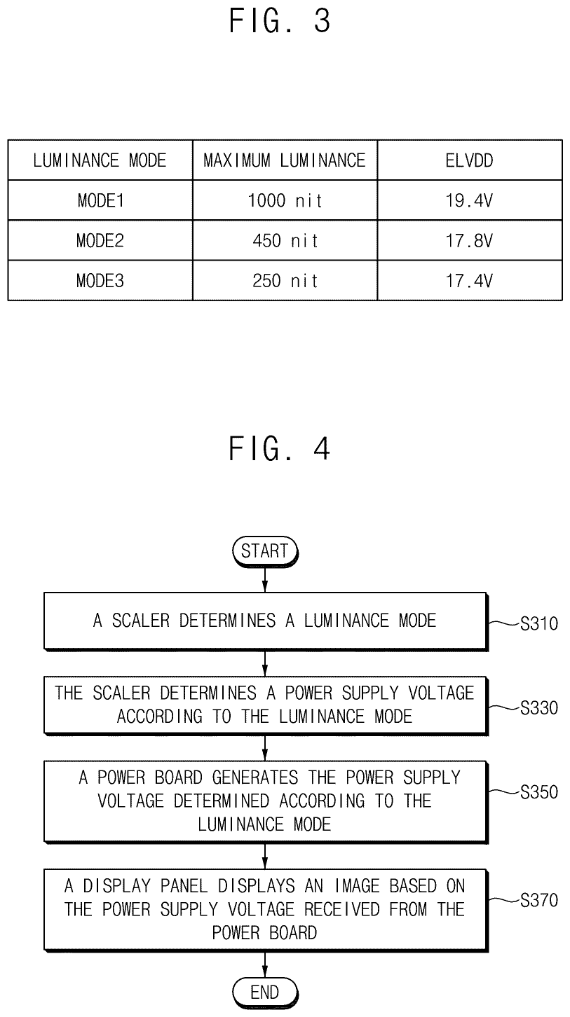

FIG. 1 is a block diagram illustrating a display device according to embodiments, FIG. 2 is a circuit diagram illustrating an example of a pixel included in a display device according to embodiments, and FIG. 3 is a diagram illustrating an example of a mode-to-power supply voltage lookup table (e.g., a mode-power supply voltage lookup table) included in a display device according to embodiments.

Referring to FIG. 1, a display device 100 according to embodiments may include a display panel 110 that includes a plurality of pixels PX, a scan driver 120 that provides scan signals SS to the plurality of pixels PX, a data driver 130 that provides data signals DS to the plurality of pixels PX, a controller 140 that controls the scan driver 120 and the data driver 130, a scaler 150 positioned between an external host processor 200 and the controller 140, and a power board 160 positioned external to a control board on which the controller 140 is located. In some embodiments, the display device 100 may be a monitor, but is not limited thereto.

The display device 100 according to one or more embodiments is a device that displays a moving image and/or a still image. The display device 100 may be applied to portable electronic devices such as mobile phones, smartphones, tablet personal computers (PCs), mobile communication terminals, electronic notebooks, electronic books, portable multimedia players (PMPs), navigations, and ultra-mobile PCs (UMPCs). For example, the display device 100 may be applied to a display unit of a television, a laptop computer, a monitor, a billboard, or the Internet of Things (IoT). Alternatively, in one or more embodiments, the display device 100 may be applied to a smartwatch, a watch phone, and/or a head-mounted display device (HMD) for implementing virtual reality and/or augmented reality.

The display panel 110 may include a plurality of data lines, a plurality of scan lines, and a plurality of pixels PX connected to the plurality of data lines and the plurality of scan lines. In some embodiments, each pixel PX may include a light-emitting element, and the display panel 110 may be a light-emitting display panel. For example, as illustrated in FIG. 2, each pixel PX may include a first transistor T1, a second transistor T2, a capacitor CST and a light-emitting element EL.

The capacitor CST may store a data signal DS transferred through the second transistor T2 from a data line DL. The capacitor CST may be referred to as a storage capacitor for storing the data signal DS, but is not limited thereto. In some embodiments, the capacitor CST may include a first electrode connected to a gate node, and a second electrode connected to a source node.

The first transistor T1 may generate a driving current based on the data signal DS stored in the capacitor CST. The first transistor T1 may be referred to as a driving transistor for generating the driving current, but is not limited thereto. In some embodiments, the first transistor T1 may include a gate connected to the gate node, a drain, which receives a first power supply voltage ELVDD (e.g., a high power supply voltage), and a source connected to the source node.

The second transistor T2 may transfer the data signal DS from the data line DL to the gate node in response to a scan signal SS. The second transistor T2 may be referred to as a scan transistor, but is not limited thereto. In some embodiments, the second transistor T2 may include a gate, which receives the scan signal SS, a drain connected to the data line DL, and a source connected to the gate node.

The light-emitting element EL may emit light based on the driving current flowing from a line, which transfers the first power supply voltage ELVDD, to a line that transfers the second power supply voltage ELVSS (e.g., a low power supply voltage). In some embodiments, the light-emitting element EL may include an anode connected to the source node, and a cathode, which receives the second power supply voltage ELVSS. In some embodiments, the light-emitting element EL may be an organic light-emitting diode (“OLED”). In other embodiments, the light-emitting element EL may be a nano light-emitting diode (“NED”), a quantum dot (“QD”) light-emitting diode, a micro light-emitting diode, an inorganic light-emitting diode, or any other suitable light-emitting element.

In some embodiments, as illustrated in FIG. 2, the first and second transistors T1 and T2 may be implemented as N-type metal oxide semiconductor (“NMOS”) transistors, but are not limited thereto. Further, although FIG. 2 illustrates an example of a pixel PX having a 2T1C structure, the pixel PX according to embodiments is not limited to the example of FIG. 2.

The scan driver 120 may generate the scan signals SS based on a scan control signal SCTRL received from the controller 140, and may sequentially provide the scan signals SS to the plurality of pixels PX on a row-by-row basis through the plurality of scan lines. In some embodiments, the scan control signal SCTRL may include a scan start signal and a scan clock signal, but is not limited thereto. In some embodiments, the scan driver 120 may be integrated or formed in the display panel 110. In other embodiments, the scan driver 120 may be implemented with one or more integrated circuits.

The data driver 130 may generate the data signals DS based on output image data ODAT and a data control signal DCTRL received from the controller 140, and may provide the data signals DS to the plurality of pixels PX through the plurality of data lines. In some embodiments, the data control signal DCTRL may include, but is not limited to, an output data enable signal, a horizontal start signal and a load signal. In some embodiments, the data driver 130 may be implemented with one or more integrated circuits. Further, the integrated circuit of the data driver 130 may be mounted on a source board, but is not limited thereto. In other embodiments, the data driver 130 and the controller 140 may be implemented with a single integrated circuit, and the single integrated circuit may be referred to as a timing controller embedded data driver (“TED”) integrated circuit.

The controller 140 (e.g., a timing controller) may receive input image data (e.g., converted input image data) IDAT′ through a scaler 150 from a host processor 200 (e.g., a system-on-chip (“SOC”), an application processor (“AP”), a graphics processing unit (“GPU”) or a graphics card). Further, the controller 140 may further receive a control signal, such as a vertical synchronization signal, a horizontal synchronization signal, an input data enable signal, a master clock signal, etc., through the scaler 150 from the host processor 200. The controller 140 may generate the output image data ODAT, the data control signal DCTRL, and the scan control signal SCTRL based on the input image data IDAT′ and the control signal. The controller 140 may control an operation of the scan driver 120 by providing the scan control signal SCTRL to the scan driver 120, and may control an operation of the data driver 130 by providing the output image data ODAT and the data control signal DCTRL to the data driver 130.

The scaler 150 may receive input image data IDAT from the host processor 200, may convert a data format of the input image data IDAT, and may provide the input image data IDAT′ having the data format suitable for the controller 140. For example, the scaler 150 may convert the input image data IDAT having a data format such as digital visual interface (“DVI”), high definition multimedia interface (“HDMI”), display port (“DP”), etc. into the input image data IDAT′ having a data format, such as low voltage differential signaling (LVDS), V-by-One, embedded display port (“eDP”), etc., but is not limited thereto. Further, in some embodiments, the scaler 150 may further perform functions, such as a resolution scaling operation, a color-tuning operation, an on-screen display (“OSD”) control operation, a power control operation, etc. The scaler 150 may be positioned external to the control board on which the controller 140 is located. In some embodiments, the scaler 150 may be implemented as an integrated circuit, and the integrated circuit may be referred to as a scaler integrated circuit. Further, the scaler integrated circuit may be located on a scaler board positioned external to the control board.

The power board 160 may generate voltages required for an operation of the display device 100. In some embodiments, the power board 160 may generate the first power supply voltage ELVDD and/or the second power supply voltage ELVSS for the plurality of pixels PX of the display panel 110, and may directly provide the first power supply voltage ELVDD and/or the second power supply voltage ELVSS to the display panel 110. That is, in the display device 100 according to embodiments, the control board on which the controller 140 is located may not include a separate power supply circuit that performs a voltage conversion operation (e.g., a direct current-direct current (“DC-DC”) conversion operation) for the voltage generated by the power board 160, and the first power supply voltage ELVDD and/or the second power supply voltage ELVSS generated by the power board 160 may be directly provided to the plurality of pixels PX without being converted. The power board 160 may be positioned external to the control board on which the controller 140 is located. That is, the power board 160 may be implemented as a separate board from the control board.

In the display device 100 according to embodiments, the scaler 150 may determine a luminance mode of the display device 100. Here, respective luminance modes may mean modes having different maximum luminances. For example, as illustrated in FIG. 3, the display device 100 may have a maximum luminance of about 1000 nit in a first luminance mode MODE1, a maximum luminance of about 450 nit in a second luminance mode MODE2, and a maximum luminance of about 250 nit in a third luminance mode MODE3, but is not limited thereto. The scaler 150 may provide a mode signal SMODE indicating the luminance mode of the display device 100 to the controller 140, and the controller 140 may control the data driver 130 to adjust a luminance of the display panel 110 in response to the mode signal SMODE. For example, even if the input image data IDAT represents the same maximum gray level (e.g., a 255-gray level) with respect to the plurality of pixels PX, the plurality of pixels PX of the display panel 110 may emit light with a luminance of about 1000 nit in the first luminance mode MODE1, may emit light with a luminance of about 450 nit in the second luminance mode MODE2, and may emit light with a luminance of about 250 nit in the third luminance mode MODE3. In some embodiments, the scaler 150 may determine the luminance mode of the display device 100 according to a setting of a user. In other embodiments, the scaler 150 may determine the luminance mode of the display device 100 in response to a signal received from the host processor 200.

Further, the scaler 150 may determine a voltage level of the first power supply voltage ELVDD according to the luminance mode, and may control the power board 160 such that the first power supply voltage ELVDD has the determined voltage level. In some embodiments, the scaler 150 may increase the voltage level of the first power supply voltage ELVDD as the maximum luminance of the luminance mode increases. For example, as illustrated in FIG. 3, the first power supply voltage ELVDD may have a voltage level of about 19.4 V in the first luminance mode MODE1 corresponding to the maximum luminance of about 1000 nit, may have a voltage level of about 17.8 V in the second luminance mode MODE2 corresponding to the maximum luminance of about 450 nit, and may have a voltage level of about 17.4 V in the third luminance mode MODE3 corresponding to the maximum luminance of about 250 nit, but is not limited thereto. To perform this operation, the scaler 150 may include a mode-to-power supply voltage lookup table (e.g., a mode-power supply voltage lookup table) 152 and a power supply voltage (or ELVDD) determiner (e.g., an ELVDD-determining block) 154.

The mode-to-power supply voltage lookup table 152 may store a plurality of voltage levels of the first power supply voltage ELVDD respectively corresponding to a plurality of luminance modes. For example, as illustrated in FIG. 3, the mode-to-power supply voltage lookup table 152 may store a voltage level of about 19.4 V for the first luminance mode MODE1 corresponding to the maximum luminance of about 1000 nit, a voltage level of about 17.8 V for the second luminance mode MODE2 corresponding to the maximum luminance of about 450 nit, and a voltage level of about 17.4 V for the third luminance mode MODE3 corresponding to the maximum luminance of about 250 nit, but is not limited thereto.

The power supply voltage determiner 154 may determine the voltage level of the first power supply voltage ELVDD corresponding to the luminance mode by using the mode-to-power supply voltage lookup table 152. In the example of FIG. 3, the power supply voltage determiner 154 may determine the voltage level of the first power supply voltage ELVDD to be about 19.4 V in the first luminance mode MODE1, determine the voltage level of the first power supply voltage ELVDD to be about 17.8 V in the second luminance mode MODE2, and may determine the voltage level of the first power supply voltage ELVDD to be about 17.4 V in the third luminance mode MODE3. The scaler 150 may control the power board 160 such that the first power supply voltage ELVDD has the determined voltage level. Thus, the first power supply voltage ELVDD of about 19.4 V may be provided to the display panel 110 in the first luminance mode MODE1 corresponding to the maximum luminance of about 1000 nit, the first power supply voltage ELVDD of about 17.8 V may be provided to the display panel 110 in the second luminance mode MODE2 corresponding to the maximum luminance of about 450 nit, and the first power supply voltage ELVDD of about 17.4 V may be provided to the display panel 110 in the third luminance mode MODE3 corresponding to the maximum luminance of about 250 nit.

In a conventional display device in which a control board does not include a separate power circuit and a power board external to the control board directly provides a power supply voltage to the display panel, a controller located on the control board may not directly control the power board, and thus the power board may provide the same power supply voltage to the display panel in different luminance modes. However, in the display device 100 according to embodiments, the scaler 150 may control the power board 160 to adjust the first power supply voltage ELVDD for the plurality of pixels PX according to the luminance mode of the display device 100. Thus, in the display device 100 according to embodiments, as the maximum luminance of the luminance mode decreases, the voltage level of the first power supply voltage ELVDD may be decreased, and power consumption of the display device 100 may be reduced.

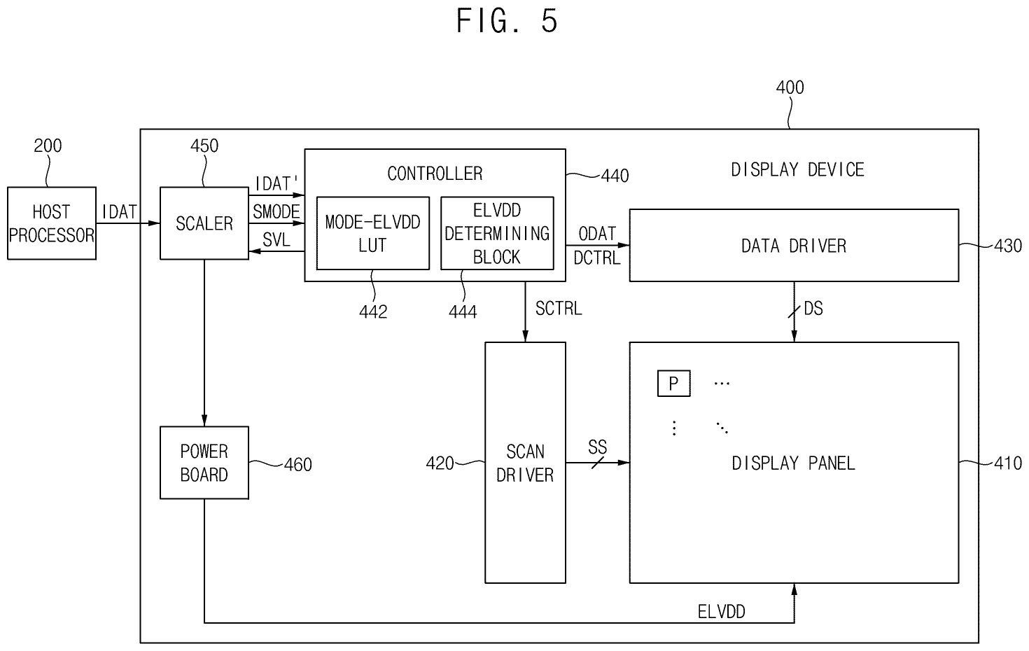

FIG. 4 is a flowchart illustrating a method of operating a display device according to embodiments.

Referring to FIGS. 1 and 4, the scaler 150 of the display device 100 may determine the luminance mode of the display device 100 (e.g., according to the setting of the user or under the control of the host processor 200) (S310), and may determine the power supply voltage ELVDD (e.g., the first power supply voltage ELVDD illustrated in FIG. 2) for the plurality of pixels PX according to the luminance mode (S330). In some embodiments, the scaler 150 may determine the power supply voltage ELVDD for the plurality of pixels PX such that the voltage level of the power supply voltage ELVDD increases as the maximum luminance of the luminance mode increases.

The scaler 150 may control the power board 160 of the display device 100 to generate the power supply voltage ELVDD that is determined according to the luminance mode, and the power board 160 may directly provide the display panel 110 with the power supply voltage ELVDD that is determined according to the luminance mode (S350). The display panel 110 may display an image based on the power supply voltage ELVDD received from the power board 160 (S370). Accordingly, in the display device 100 in which the power board 160 external to the control board directly provide the power supply voltage ELVDD to the plurality of pixels PX, the voltage level of the power supply voltage ELVDD generated by the power board 160 may be adjusted, and the power consumption of the display device 100 may be reduced.

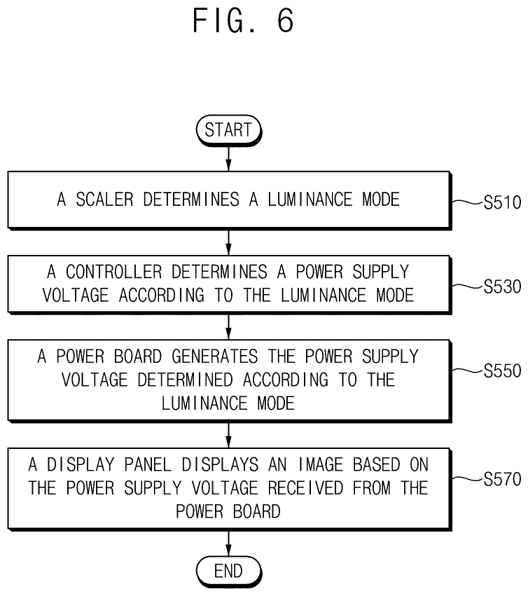

FIG. 5 is a block diagram illustrating a display device according to embodiments.

Referring to FIG. 5, a display device 400 may include a display panel 410, a scan driver 420, a data driver 430, a controller 440, a scaler 450, and a power board 460. The display device 400 of FIG. 5 may have a similar configuration and a similar operation to a display device 100 of FIG. 1, except that the controller 440 may determine a power supply voltage ELVDD according to a luminance mode.

The controller 440 may receive a mode signal SMODE indicating the luminance mode of the display device 400 from the scaler 450, and may control the data driver 430 to adjust a luminance of the display panel 410 in response to the mode signal SMODE. Further, the controller 440 may determine the power supply voltage ELVDD (e.g., a high power supply voltage) for a plurality of pixels PX according to the luminance mode indicated by the mode signal SMODE. In some embodiments, the controller 440 may determine the power supply voltage ELVDD for the plurality of pixels PX such that a voltage level of the power supply voltage ELVDD increases as a maximum luminance of the luminance mode increases.

To determine the power supply voltage ELVDD according to the luminance mode, in some embodiments, the controller 440 may include a mode-to-power-supply-voltage (or ELVDD) lookup table 442 and a power supply voltage (or ELVDD) determiner (e.g., ELVDD-determining block) 444. The mode-to-power supply voltage lookup table 442 may store a plurality of voltage levels of the power supply voltage ELVDD respectively corresponding to a plurality of luminance modes. The power supply voltage determiner 444 may receive the mode signal SMODE indicating the luminance mode from the scaler 450, and may determine the voltage level of the power supply voltage ELVDD corresponding to the luminance mode indicated by the mode signal SMODE by using the mode-to-power supply voltage lookup table 442.

The controller 440 may provide a power supply voltage level signal SVL indicating the voltage level of the power supply voltage ELVDD determined by the power supply voltage determiner 444 to the scaler 450. The scaler 450 may control the power board 460 in response to the power supply voltage level signal SVL such that the power supply voltage ELVDD has the voltage level indicated by the power supply voltage level signal SVL. The power board 460 may provide the power supply voltage ELVDD having the voltage level indicated by the power supply voltage level signal SVL to the display panel 410, and the display panel 410 may display an image based on the power supply voltage ELVDD having the voltage level indicated by the power supply voltage level signal SVL. Accordingly, in a display device 400 in which the power board 460 external to a control board directly provides the power supply voltage ELVDD to the plurality of pixels PX, the voltage level of the power supply voltage ELVDD generated by the power board 460 may be adjusted, and power consumption of the display device 400 may be reduced.

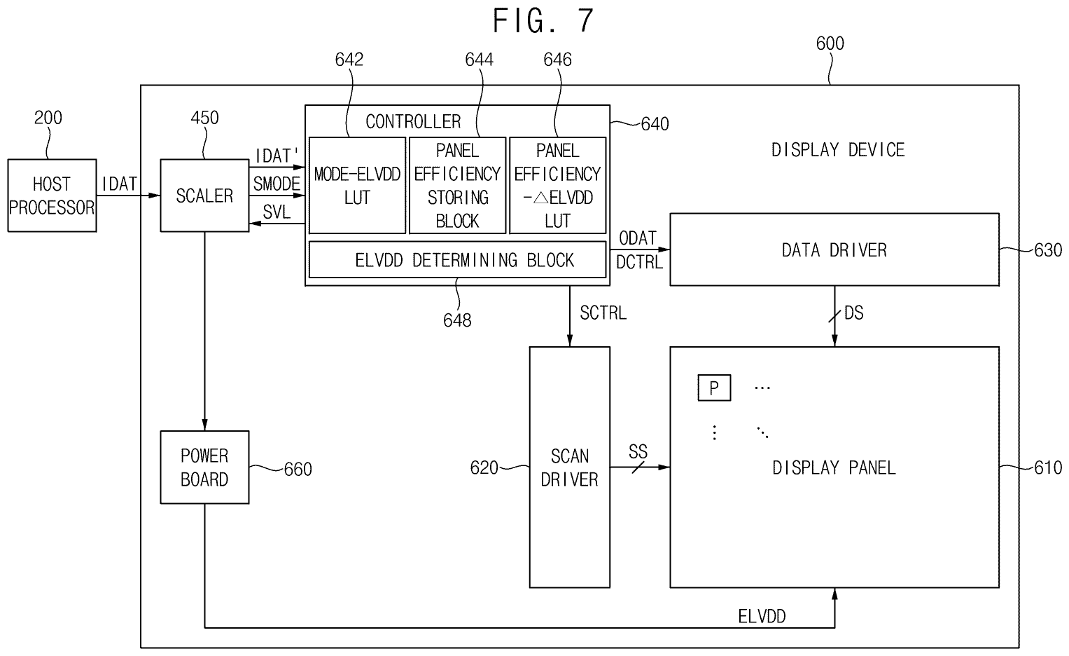

FIG. 6 is a flowchart illustrating a method of operating a display device according to embodiments.

Referring to FIGS. 5 and 6, the scaler 450 of the display device 400 may determine the luminance mode of the display device 400, and may provide the mode signal SMODE indicating the luminance mode to the controller 440 of the display device 400 (S510). The controller 440 may determine the voltage level of the power supply voltage ELVDD for the plurality of pixels PX according to the luminance mode indicated by the mode signal SMODE, and may provide the power supply voltage level signal SVL indicating the voltage level of the power supply voltage ELVDD to the scaler 450 (S530).

The scaler 450 may control the power board 460 of the display device 400 to generate the power supply voltage ELVDD having the voltage level indicated by the power supply voltage level signal SVL, and the power board 460 may provide the display panel 410 with the power supply voltage ELVDD that is determined according to the luminance mode (S550). The display panel 410 may display an image based on the power supply voltage ELVDD received from the power board 460 (S570). Accordingly, in the display device 400 in which the power board 460 external to a control board directly provides the power supply voltage ELVDD to the plurality of pixels PX, the voltage level of the power supply voltage ELVDD generated by the power board 460 may be adjusted, and the power consumption of the display device 400 may be reduced.

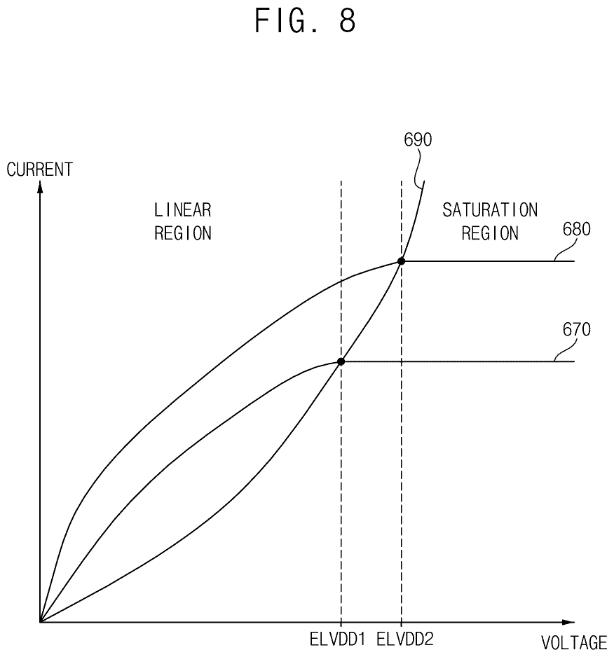

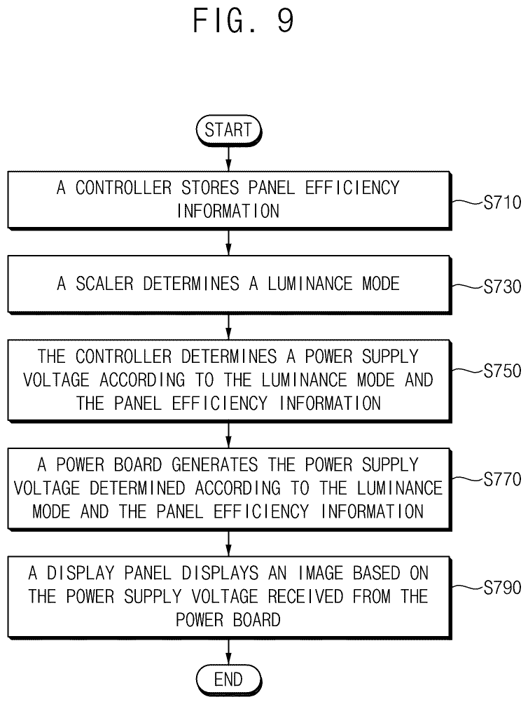

FIG. 7 is a block diagram illustrating a display device according to embodiments, and FIG. 8 is a diagram for describing an example of power supply voltages in display devices having different panel efficiencies.

Referring to FIG. 7, a display device 600 may include a display panel 610, a scan driver 620, a data driver 630, a controller 640, a scaler 650, and a power board 660. The display device 600 of FIG. 7 may have a similar configuration and a similar operation to a display device 400 of FIG. 5, except that the controller 640 may determine a power supply voltage ELVDD based on a panel efficiency of the display panel 610 as well as a luminance mode.

The controller 640 may determine the power supply voltage ELVDD for a plurality of pixels PX based on the luminance mode and the panel efficiency. Here, the panel efficiency may represent a ratio of a panel luminance to a panel current. For example, in cases where the same panel current is applied, a display panel 610 having relatively high panel efficiency may emit light with a higher luminance than a display panel 610 having relatively low panel efficiency. In some embodiments, the controller 640 may determine the power supply voltage ELVDD for the plurality of pixels PX such that a voltage level of the power supply voltage ELVDD may increase as a maximum luminance of the luminance mode increases, and may decrease as the panel efficiency increases. That is, in the same luminance mode, the power supply voltage ELVDD for the display panel 610 having the relatively high panel efficiency may be lower than the power supply voltage ELVDD for the display panel 610 having the relatively low panel efficiency.

FIG. 8 illustrates a voltage-current characteristic 670 of the display panel 610 (or a drain-source current characteristic according to a drain-source voltage of a first transistor of each pixel PX of the display panel 610) having the relatively high panel efficiency, a voltage-current characteristic 680 of the display panel 610 having the relatively low panel efficiency, and a line 690 that distinguishes a linear region and a saturation region. The line 690 distinguishing the linear region and the saturation region may represent a desired power supply voltage ELVDD. For example, to emit light with the same panel luminance, a panel current of the display panel 610 having the relatively high panel efficiency (e.g., the display panel 610 having the voltage-current characteristic 670) may be less than a panel current of the display panel 610 having the relatively low panel efficiency (e.g., the display panel 610 having voltage-current characteristic 680). Further, because the panel current of the display panel 610 having the voltage-current characteristic 670 is less than the panel current of the display panel 610 having the voltage-current characteristic 680, as illustrated in FIG. 8, the power supply voltage ELVDD1 for the display panel 610 having the relatively high panel efficiency (e.g., the display panel 610 having the voltage-current characteristic 670) may be lower than the power supply voltage ELVDD2 for the display panel 610 having the relatively low panel efficiency (e.g., the display panel 610 having the voltage-current characteristic 680). Thus, by decreasing the voltage level of the power supply voltage ELVDD for the display panel 610 having the relatively high panel efficiency (e.g., the display panel 610 having the voltage-current characteristic 670), the power consumption of the display device 600 including the display panel 610 having the voltage-current characteristic 670 may be reduced.

To determine the power supply voltage ELVDD according to the luminance mode and the panel efficiency, in some embodiments, the controller 640 may include a mode-to-power supply voltage (or mode-ELVDD, or mode-to-ELVDD) lookup table 642, a panel efficiency bank (e.g., a panel-efficiency-storing block) 644, a panel efficiency-to-change amount (or panel efficiency-ΔELVDD, or panel efficiency-to-ΔELVDD) lookup table 646, and a power supply voltage determiner (e.g., ELVDD-determining block) 648. The mode-to-power supply voltage lookup table 642 may store a plurality of voltage levels of the power supply voltage ELVDD respectively corresponding to a plurality of luminance modes. The panel efficiency bank 644 may store panel efficiency information indicating the panel efficiency of the display panel 610. In some embodiments, when a correction operation (e.g., a luminance and color correction (“LCC”) operation) is performed on the display device 600, the panel efficiency information may be stored in the panel efficiency bank 644. The panel efficiency-to-change amount lookup table 646 may store a plurality of power supply voltage level change amounts respectively corresponding to a plurality of panel efficiencies.

The power supply voltage determiner 648 may receive a mode signal SMODE indicating the luminance mode from the scaler 650, may determine an intermediate voltage level of the power supply voltage ELVDD corresponding to the luminance mode indicated by the mode signal SMODE by using the mode-to-power supply voltage lookup table 642, may receive the panel efficiency information from the panel efficiency bank 644, may receive a power supply voltage level change amount corresponding to the panel efficiency indicated by the panel efficiency information from the panel efficiency-to-change amount lookup table 646, and may determine a final voltage level of the power supply voltage ELVDD by adjusting the intermediate voltage level of the power supply voltage ELVDD by the power supply voltage level change amount corresponding to the panel efficiency.

The controller 640 may provide the scaler 650 with a power supply voltage level signal SVL indicating the final voltage level of the power supply voltage ELVDD determined by the power supply voltage determiner 648. The scaler 650 may control the power board 660 in response to the power supply voltage level signal SVL such that the power supply voltage ELVDD may have the final voltage level indicated by the power supply voltage level signal SVL. The power board 660 may provide the display panel 610 with the power supply voltage ELVDD having the final voltage level indicated by the power supply voltage level signal SVL, and the display panel 610 may display an image based on the power supply voltage ELVDD having the final voltage level indicated by the power supply voltage level signal SVL. Accordingly, in the display device 600 in which the power board 660 external to a control board directly provides the power supply voltage ELVDD to the plurality of pixels PX, the voltage level of the power supply voltage ELVDD generated by the power board 660 may be adjusted based on the luminance mode and the panel efficiency, and power consumption of the display device 600 may be reduced.

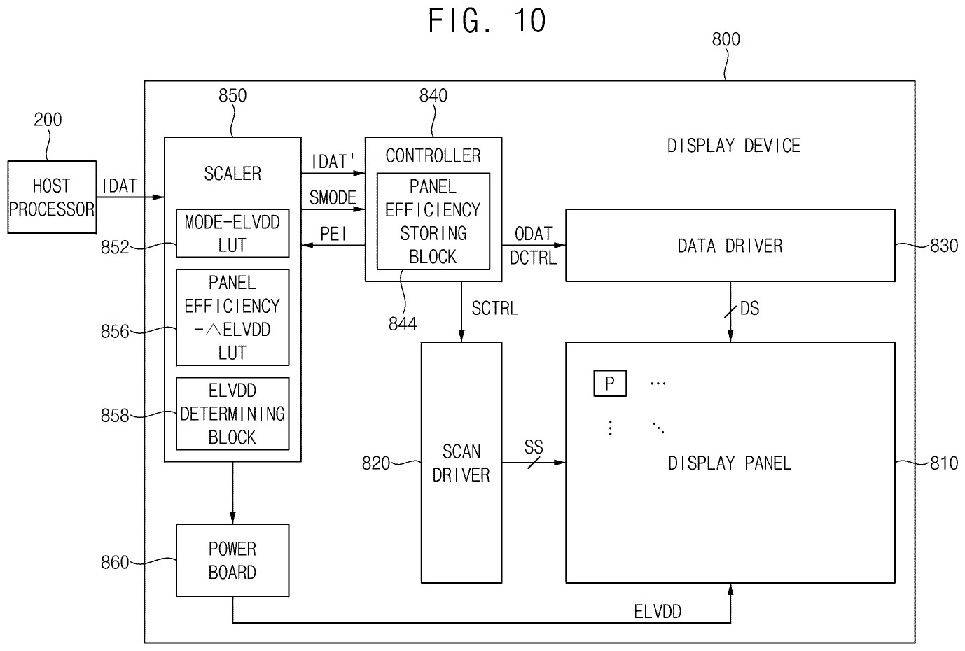

FIG. 9 is a flowchart illustrating a method of operating a display device according to embodiments.

Referring to FIGS. 7 and 9, the controller 640 of the display device 600 may store the panel efficiency information indicating the panel efficiency of the display panel 610 in the panel efficiency bank 644 (S710). The scaler 650 of the display device 600 may determine the luminance mode of the display device 600, and may provide the mode signal SMODE indicating the luminance mode to the controller 640 of the display device 600 (S730). The controller 640 may determine the voltage level of the power supply voltage ELVDD for the plurality of pixels PX based on the luminance mode indicated by the mode signal SMODE and based on the panel efficiency information stored in the panel efficiency bank 644, and may provide the power supply voltage level signal SVL indicating the voltage level of the power supply voltage ELVDD to the scaler 650 (S750).

The scaler 650 may control the power board 660 of the display device 600 to generate the power supply voltage ELVDD having the voltage level indicated by the power supply voltage level signal SVL, and the power board 660 may provide the display panel 610 with the power supply voltage ELVDD that is determined based on the luminance mode and based on the panel efficiency information (S770). The display panel 610 may display the image based on the power supply voltage ELVDD received from the power board 660 (S790). Accordingly, in the display device 600 in which the power board 660 external to the control board directly provides the power supply voltage ELVDD to the plurality of pixels PX, the voltage level of the power supply voltage ELVDD generated by the power board 660 may be adjusted based on the luminance mode and the panel efficiency, and the power consumption of the display device 600 can be reduced.

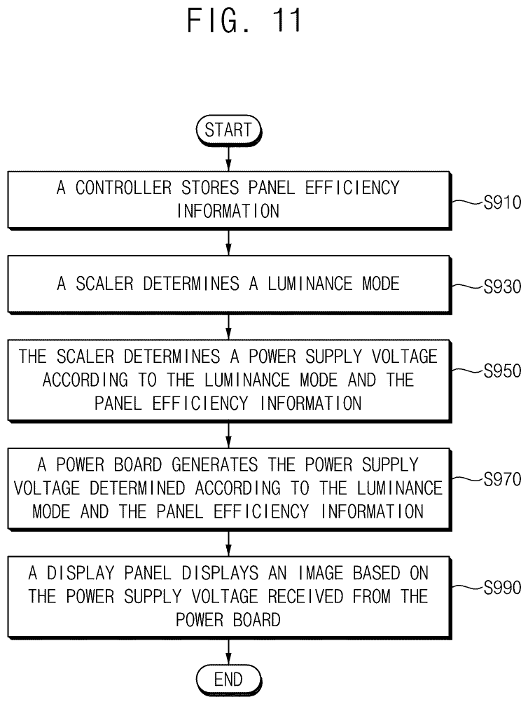

FIG. 10 is a block diagram illustrating a display device according to embodiments.

Referring to FIG. 10, a display device 800 may include a display panel 810, a scan driver 820, a data driver 830, a controller 840, a scaler 850, and a power board 860. The display device 800 of FIG. 10 may have a similar configuration and a similar operation to a display device 100 of FIG. 1, except that the scaler 850 may determine a power supply voltage ELVDD based on a panel efficiency of the display panel 810 as well as a luminance mode.

The scaler 850 may determine the power supply voltage ELVDD for a plurality of pixels PX based on the luminance mode and the panel efficiency. In some embodiments, the scaler 850 may determine the power supply voltage ELVDD for the plurality of pixels PX such that a voltage level of the power supply voltage ELVDD may increase as a maximum luminance of the luminance mode increases, and may decrease as the panel efficiency increases.

To determine the power supply voltage ELVDD according to the luminance mode and the panel efficiency, in some embodiments, the controller 840 may include a panel efficiency bank 844, and the scaler 850 may include a mode-to-power supply voltage (or mode-ELVDD, or mode-to-ELVDD) lookup table 852, a panel efficiency-to-change amount (or panel efficiency-ΔELVDD, or panel efficiency-to-ΔELVDD) lookup table 856 and a power supply voltage determiner (e.g., ELVDD-determining block) 858. The panel efficiency bank 844 may store panel efficiency information PEI indicating the panel efficiency of the display panel 810. The mode-to-power supply voltage lookup table 842 may store a plurality of voltage levels of the power supply voltage ELVDD respectively corresponding to a plurality of luminance modes. The panel efficiency-to-change amount lookup table 856 may store a plurality of power supply voltage level change amounts respectively corresponding to a plurality of panel efficiencies.

The power supply voltage determiner 858 may determine an intermediate voltage level of the power supply voltage ELVDD corresponding to the luminance mode determined by the scaler 850 by using the mode-to-power supply voltage lookup table 852, may receive the panel efficiency information PEI from the controller 840, may receive a power supply voltage level change amount corresponding to the panel efficiency indicated by the panel efficiency information PEI from the panel efficiency-to-change amount lookup table 856, and may determine a final voltage level of the power supply voltage ELVDD by adjusting the intermediate voltage level of the power supply voltage ELVDD by the power supply voltage level change amount corresponding to the panel efficiency.

The scaler 850 may control the power board 860 such that the power supply voltage ELVDD has the final voltage level that is determined based on the luminance mode and the panel efficiency by the power supply voltage determiner 858. The power board 860 may provide the display panel 810 with the power supply voltage ELVDD having the final voltage level that is determined based on the luminance mode and the panel efficiency, and the display panel 810 may display an image based on the power supply voltage ELVDD having the final voltage level that is determined based on the luminance mode and the panel efficiency. Accordingly, in a display device 800 in which the power board 860 external to a control board directly provides the power supply voltage ELVDD to the plurality of pixels PX, the voltage level of the power supply voltage ELVDD generated by the power board 860 may be adjusted based on the luminance mode and based on the panel efficiency, and power consumption of the display device 800 may be reduced.

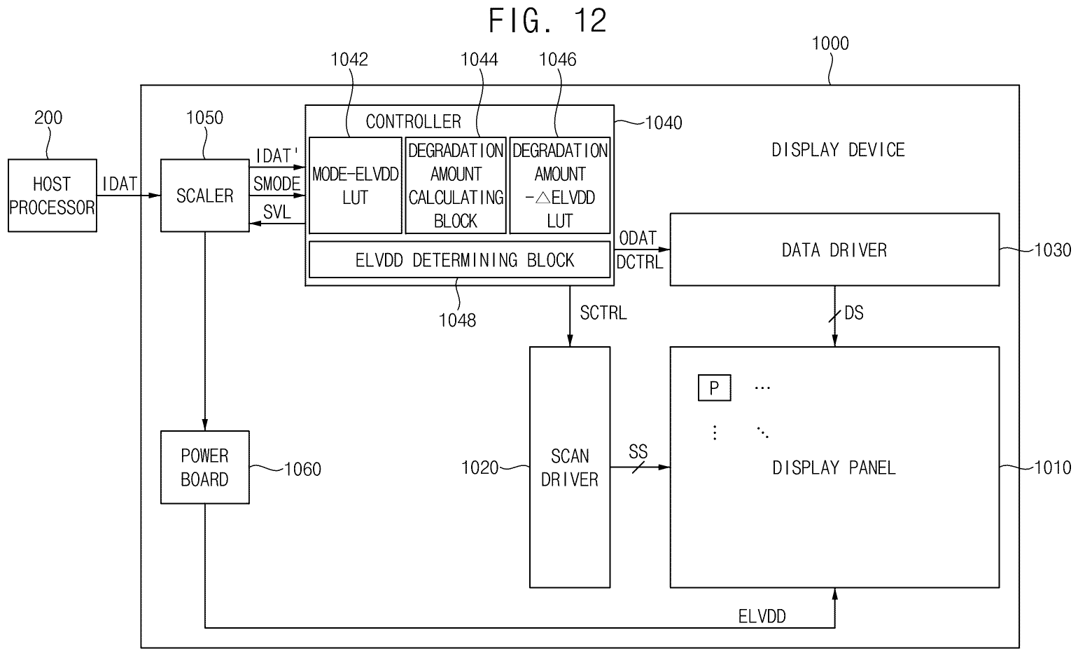

FIG. 11 is a flowchart illustrating a method of operating a display device according to embodiments.

Referring to FIGS. 10 and 11, the controller 840 of the display device 800 may store the panel efficiency information PEI indicating the panel efficiency of the display panel 810 in the panel efficiency bank 844, and may provide the panel efficiency information PEI to the scaler 850 of the display device 800 (S910). The scaler 850 may determine the luminance mode of the display device 800 (S930). Further, the scaler 850 may determine the voltage level of the power supply voltage ELVDD for the plurality of pixels PX based on the luminance mode and the panel efficiency information PEI (S950).

The scaler 850 may control the power board 860 of the display device 800 to generate the power supply voltage ELVDD determined based on the luminance mode and the panel efficiency information PEI, and the power board 860 may provide the display panel 810 with the power supply voltage ELVDD determined based on the luminance mode and the panel efficiency information PEI (S970). The display panel 810 may display the image based on the power supply voltage ELVDD received from the power board 860 (S990). Accordingly, in the display device 800 in which the power board 860 external to the control board directly provides the power supply voltage ELVDD to the plurality of pixels PX, the voltage level of the power supply voltage ELVDD generated by the power board 860 may be adjusted based on the luminance mode and the panel efficiency, and the power consumption of the display device 800 may be reduced.

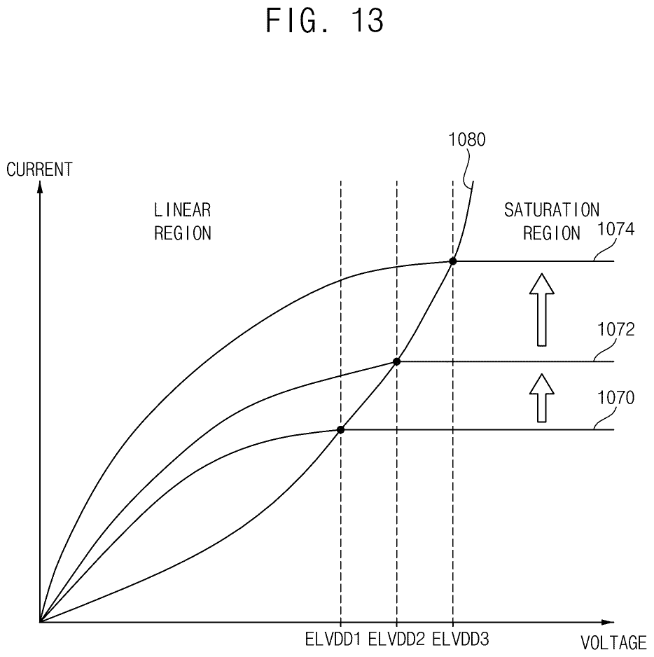

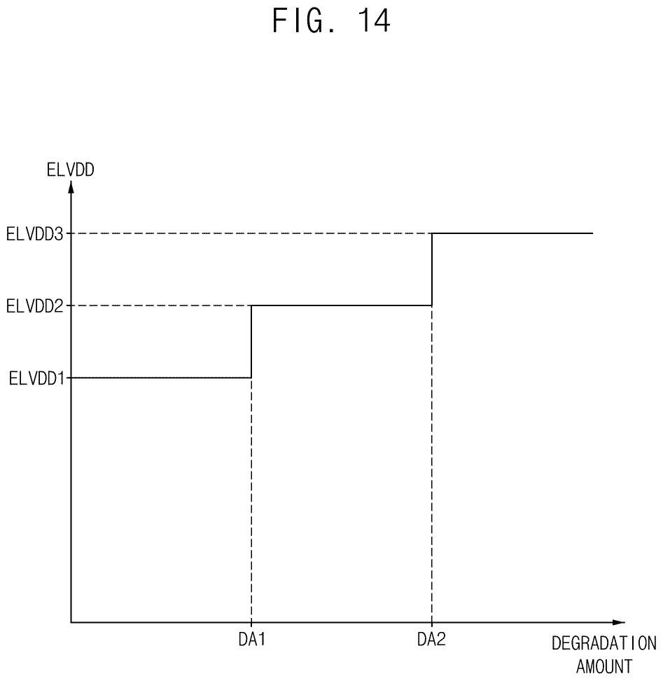

FIG. 12 is a block diagram illustrating a display device according to embodiments, and FIG. 13 and FIG. 14 are diagrams for describing examples in which a power supply voltage is increased as a degradation amount of a display panel increases.

Referring to FIG. 12, a display device 1000 may include a display panel 1010, a scan driver 1020, a data driver 1030, a controller 1040, a scaler 1050, and a power board 1060. The display device 1000 of FIG. 12 may have a similar configuration and a similar operation to a display device 400 of FIG. 5 or a display device 600 of FIG. 7, except that the controller 1040 may determine a power supply voltage ELVDD based on a degradation amount of the display panel 1010 as well as based on a luminance mode.

The controller 1040 may determine the power supply voltage ELVDD for a plurality of pixels PX based on the luminance mode and the degradation amount. Here, the degradation amount of the display panel 1010 may correspond to degradation amounts of the plurality of pixels PX of the display panel 1010. Further, the degradation amount of the display panel 1010 may increase as a driving time of the display device 1000 increases. In some embodiments, the controller 1040 may determine the power supply voltage ELVDD for the plurality of pixels PX such that a voltage level of the power supply voltage ELVDD may increase as a maximum luminance of the luminance mode increases, and may increase as the degradation amount increases. That is, in the same luminance mode, the power supply voltage ELVDD for the display panel 1010 having a relatively large degradation amount may be higher than the power supply voltage ELVDD for the display panel 1010 having a relatively low degradation amount.

FIG. 13 illustrates a voltage-current characteristic 1070 of the display panel 1010 (or a drain-source current characteristic according to a drain-source voltage of a first transistor of each pixel PX of the display panel 1010) that is not degraded, a voltage-current characteristic 1072 of the display panel 1010 that is degraded by a first degradation amount, a voltage-current characteristic 1074 of the display panel 1010 that is degraded by a second degradation amount that is greater than the first degradation amount, and a line 1080 that distinguishes a linear region and a saturation region and that represents a desired power supply voltage ELVDD. For example, to emit light with the same luminance, the power supply voltage ELVDD2 for the display panel 1010 having the first degradation amount (e.g., the display panel 1010 having the voltage-current characteristic 1072) may be higher than the power supply voltage ELVDD1 for the display panel 1010 that is not degraded (e.g., the display panel 1010 having the voltage-current characteristic 1070). Further, to emit light with the same luminance, the power supply voltage ELVDD3 for the display panel 1010 having the second degradation amount (e.g., the display panel 1010 having the voltage-current characteristic 1074) may be higher than the power supply voltage ELVDD2 for the display panel 1010 having the first degradation amount (e.g., the display panel 1010 having the voltage-current characteristic 1072).

In some embodiments, as illustrated in FIG. 14, the controller 1040 may determine the power supply voltage ELVDD as a first power supply voltage ELVDD1 when the degradation amount of the display panel 1010 is less than a first degradation amount DA1, may determine the power supply voltage ELVDD as a second power supply voltage ELVDD2 that is higher than the first power supply voltage ELVDD1 when the degradation amount of the display panel 1010 is greater than or equal to the first degradation amount DA1 and less than a second degradation amount DA2, and may determine the power supply voltage ELVDD as a third power supply voltage ELVDD3 that is higher than the second power supply voltage ELVDD2 when the degradation amount of the display panel 1010 is greater than or equal to the second degradation amount DA2.

To determine the power supply voltage ELVDD according to the luminance mode and the degradation amount, in some embodiments, the controller 1040 may include a mode-to-power supply voltage (or mode-ELVDD, or mode-to-ELVDD) lookup table 1042, a degradation amount calculator (e.g., a degradation-amount-calculating block) 1044, a degradation amount-to-change amount (or degradation amount-ΔELVDD, or degradation amount-to-ΔELVDD) lookup table 1046 and a power supply voltage determiner (e.g., ELVDD-determining block) 1048. The mode-to-power supply voltage lookup table 1042 may store a plurality of voltage levels of the power supply voltage ELVDD respectively corresponding to a plurality of luminance modes. The degradation amount calculator 1044 may calculate the degradation amount of the display panel 1010. In some embodiments, the degradation amount calculator 1044 may accumulate input image data IDAT′ received from the scaler 1050 to calculate the degradation amount of the display panel 1010. The degradation amount-to-change amount lookup table 1046 may store a plurality of power supply voltage level change amounts respectively corresponding to a plurality of degradation amounts.

The power supply voltage determiner 1048 may receive a mode signal SMODE indicating the luminance mode from the scaler 1050, may determine an intermediate voltage level of the power supply voltage ELVDD corresponding to the luminance mode indicated by the mode signal SMODE by using the mode-to-power supply voltage lookup table 1042, may receive the degradation amount of the display panel 1010 from the degradation amount calculator 1044, may receive a power supply voltage level change amount corresponding to the degradation amount from the degradation amount-to-change amount lookup table 1046, and may determine a final voltage level of the power supply voltage ELVDD by adjusting the intermediate voltage level of the power supply voltage ELVDD by the power supply voltage level change amount corresponding to the degradation amount.

The controller 1040 may provide a power supply voltage level signal SVL, which indicates the final voltage level of the power supply voltage ELVDD as determined by the power supply voltage determiner 1048, to the scaler 1050. The scaler 1050 may control the power board 1060 in response to the power supply voltage level signal SVL such that the power supply voltage ELVDD has the final voltage level indicated by the power supply voltage level signal SVL. The power board 1060 may provide the display panel 1010 with the power supply voltage ELVDD having the final voltage level indicated by the power supply voltage level signal SVL, and the display panel 1010 may display an image based on the power supply voltage ELVDD having the final voltage level indicated by the power supply voltage level signal SVL. Accordingly, in the display device 1000 in which the power board 1060 external to a control board directly provides the power supply voltage ELVDD to the plurality of pixels PX, the voltage level of the power supply voltage ELVDD generated by the power board 1060 may be adjusted based on the luminance mode and the degradation amount, and power consumption of the display device 1000 may be reduced.

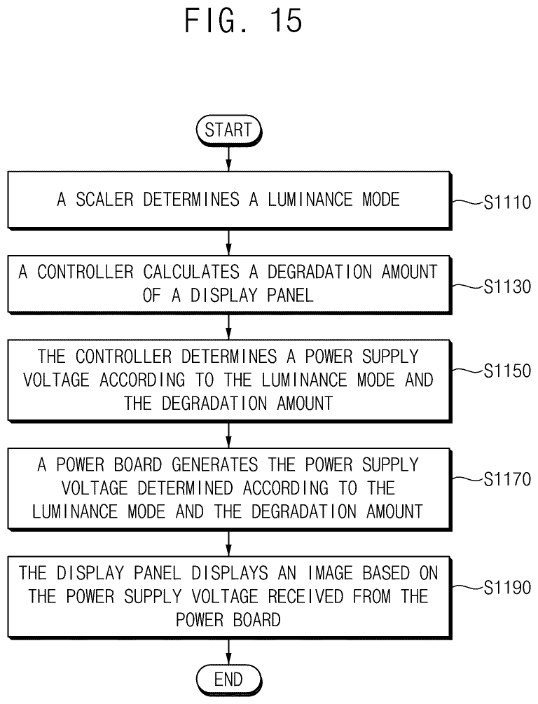

FIG. 15 is a flowchart illustrating a method of operating a display device according to embodiments.

Referring to FIGS. 12 and 15, the scaler 1050 of the display device 1000 may determine the luminance mode of the display device 1000, and may provide the mode signal SMODE indicating the luminance mode to the controller 1040 of the display device 1000 (S1110). The degradation amount calculator 1044 of the controller 1040 may calculate the degradation amount of the display panel 1010 by accumulating the input image data IDAT′ received from the scaler 1050 (S1130). The controller 1040 may determine the voltage level of the power supply voltage ELVDD for the plurality of pixels PX based on the luminance mode indicated by the mode signal SMODE and based on the degradation amount calculated by the degradation amount calculator 1044, and may provide the power supply voltage level signal SVL indicating the voltage level of the power supply voltage ELVDD to the scaler 1050 (S1150).

The scaler 1050 may control the power board 1060 of the display device 1000 to generate the power supply voltage ELVDD having the voltage level indicated by the power supply voltage level signal SVL, and the power board 1060 may provide the display panel 1010 with the power supply voltage ELVDD determined based on the luminance mode and the degradation amount (S1170). The display panel 1010 may display the image based on the power supply voltage ELVDD received from the power board 1060 (S1190). Accordingly, in the display device 1000 in which the power board 1060 external to the control board directly provides the power supply voltage ELVDD to the plurality of pixels PX, the voltage level of the power supply voltage ELVDD generated by the power board 1060 may be adjusted based on the luminance mode and the degradation amount, and the power consumption of the display device 1000 may be reduced.

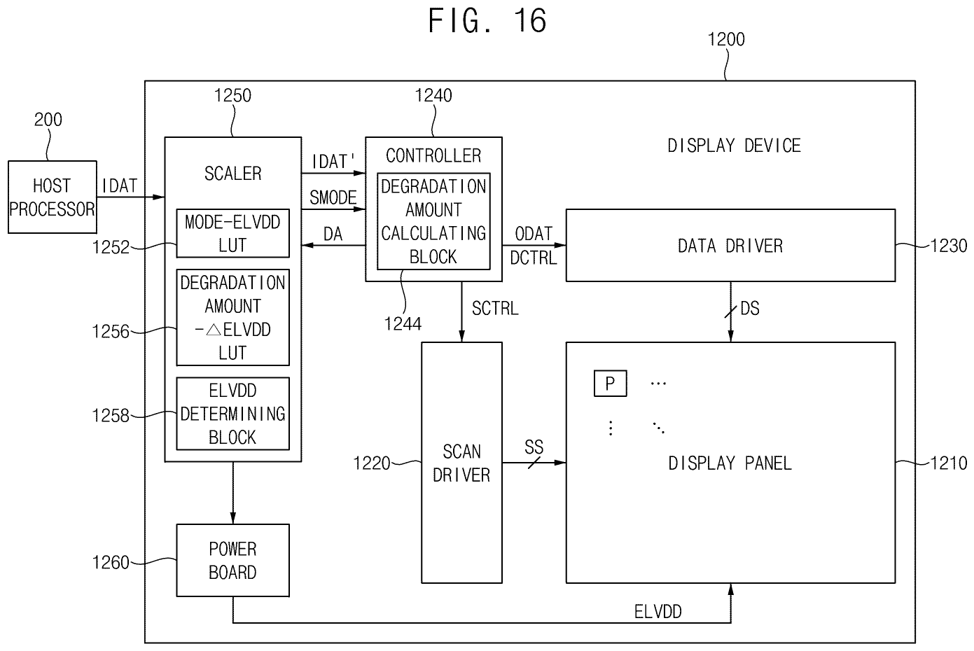

FIG. 16 is a block diagram illustrating a display device according to embodiments.

Referring to FIG. 16, a display device 1200 may include a display panel 1210, a scan driver 1220, a data driver 1230, a controller 1240, a scaler 1250, and a power board 1260. The display device 1200 of FIG. 16 may have a similar configuration and a similar operation to a display device 100 of FIG. 1 or a display device 800 of FIG. 10, except that the scaler 1250 may determine a power supply voltage ELVDD based on a degradation amount DA of the display panel 1210 as well as based on a luminance mode.

The scaler 1250 may determine the power supply voltage ELVDD for a plurality of pixels PX based on the luminance mode and the degradation amount DA. In some embodiments, the scaler 1250 may determine the power supply voltage ELVDD for the plurality of pixels PX such that a voltage level of the power supply voltage ELVDD may increase as a maximum luminance of the luminance mode increases, and may increase as the degradation amount DA increases.

To determine the power supply voltage ELVDD according to the luminance mode and the degradation amount DA, in some embodiments, the controller 1240 may include a degradation amount calculator 1244, and the scaler 1250 may include a mode-to-power supply voltage (or mode-ELVDD, or mode-to-ELVDD) lookup table 1252, a degradation amount-to-change amount (or degradation amount-ΔELVDD, or degradation amount-to-ΔELVDD) lookup table 1256, and a power supply voltage determiner (e.g., ELVDD-determining block) 1258. The degradation amount calculator 1244 may accumulate input image data IDAT′ received from the scaler 1250 to calculate the degradation amount DA of the display panel 1210. The mode-to-power supply voltage lookup table 1252 may store a plurality of voltage levels of the power supply voltage ELVDD respectively corresponding to a plurality of luminance modes. The degradation amount-to-change amount lookup table 1256 may store a plurality of power supply voltage level change amounts respectively corresponding to a plurality of degradation amounts.

The power supply voltage determiner 1258 may determine an intermediate voltage level of the power supply voltage ELVDD corresponding to the luminance mode determined by the scaler 1250 by using the mode-to-power supply voltage lookup table 1252, may receive the degradation amount DA of the display panel from the controller 1240, may receive a power supply voltage level change amount corresponding to the degradation amount DA from the degradation amount-to-change amount lookup table 1256, and may determine a final voltage level of the power supply voltage ELVDD by adjusting the intermediate voltage level of the power supply voltage ELVDD by the power supply voltage level change amount corresponding to the degradation amount DA.

The scaler 1250 may control the power board 1260 such that the power supply voltage ELVDD may have the final voltage level determined by the power supply voltage determiner 1258 based on the luminance mode and the degradation amount DA. The power board 1260 may provide the display panel 1210 with the power supply voltage ELVDD having the final voltage level determined based on the luminance mode and based on the degradation amount DA, and the display panel 1210 may display an image based on the power supply voltage ELVDD having the final voltage level determined based on the luminance mode and the degradation amount DA. Accordingly, in a display device 1200 in which the power board 1260 external to a control board directly provides the power supply voltage ELVDD to the plurality of pixels PX, the voltage level of the power supply voltage ELVDD generated by the power board 1260 may be adjusted based on the luminance mode and based on the degradation amount DA, and power consumption of the display device 1200 may be reduced.

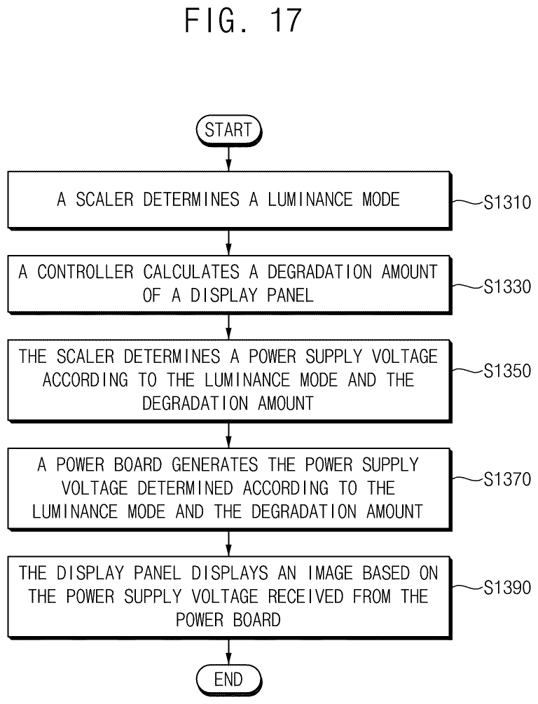

FIG. 17 is a flowchart illustrating a method of operating a display device according to embodiments.

Referring to FIGS. 16 and 17, the scaler 1250 of the display device 1200 may determine the luminance mode of the display device 1200 (S1310). The degradation amount calculator 1244 of the controller 1240 may accumulate the input image data IDAT′ received from the scaler 1250 to calculate the degradation amount DA of the display panel 1210, and may provide the degradation amount DA of the display panel 1210 to the scaler 1250 (S1330). The scaler 1250 may determine the voltage level of the power supply voltage ELVDD for the plurality of pixels PX based on the luminance mode and the degradation amount DA (S1350).

The scaler 1250 may control the power board 1260 of the display device 1200 to generate the power supply voltage ELVDD having the voltage level determined based on the luminance mode and based on the degradation amount DA, and the power board 1260 may provide the display panel 1210 with the power supply voltage ELVDD determined based on the luminance mode and the degradation amount DA (S1370). The display panel 1210 may display the image based on the power supply voltage ELVDD received from the power board 1260 (S1390). Accordingly, in the display device 1200 in which the power board 1260 external to the control board directly provides the power supply voltage ELVDD to the plurality of pixels PX, the voltage level of the power supply voltage ELVDD generated by the power board 1260 may be adjusted based on the luminance mode and the degradation amount DA, and the power consumption of the display device 1200 may be reduced.

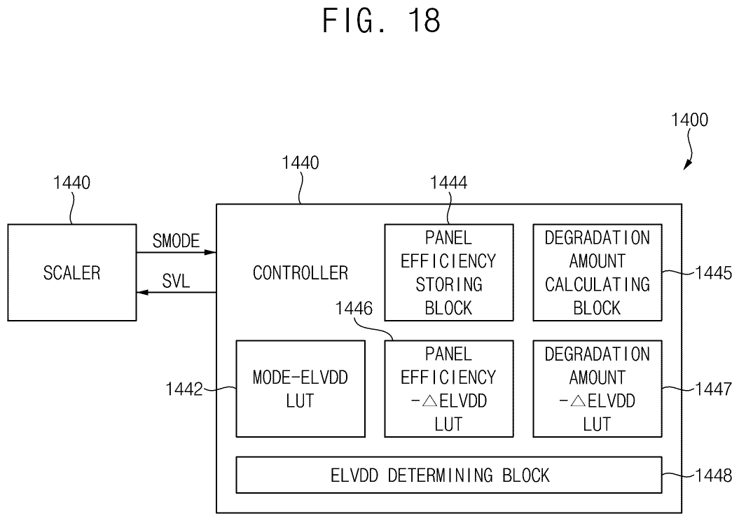

FIG. 18 is a block diagram illustrating a portion of a display device according to embodiments.

Referring to FIG. 18, to determine a power supply voltage ELVDD based on a luminance mode, based on a panel efficiency, and based on a degradation amount, a controller 1440 of a display device 1400 may include a mode-to-power supply voltage (or mode-ELVDD, or mode-to-ELVDD) lookup table 1442, a panel efficiency bank (or panel-efficiency-storin block) 1444, a degradation amount calculator (or degradation-amount-calculating block) 1445, a panel efficiency-to-change amount (or panel efficiency-ΔELVDD, or panel efficiency-to-ΔELVDD) lookup table 1446, a degradation amount-to-change amount (or degradation amount-ΔELVDD, or degradation amount-to-ΔELVDD) lookup table 1447, and a power supply voltage determiner (e.g., ELVDD-determining block) 1448.

In some embodiments, the power supply voltage determiner 1448 may receive a mode signal SMODE indicating the luminance mode from the scaler 1450, may determine a first intermediate voltage level corresponding to the luminance mode by using the mode-to-power supply voltage lookup table 1442, may receive panel efficiency information indicating the panel efficiency from the panel efficiency bank 1444, may receive a first power supply voltage level change amount corresponding to the panel efficiency from the panel efficiency-to-change amount lookup table 1446, may adjust the first intermediate voltage level by the first power supply voltage level change amount corresponding to the panel efficiency to determine a second intermediate voltage level, may receive the degradation amount from the degradation amount calculator 1445, may receive a second power supply voltage level change amount corresponding to the degradation amount from the degradation amount-to-change amount lookup table 1447, and may determine a final voltage level of the power supply voltage ELVDD by adjusting the second intermediate voltage level by the second power supply voltage level change amount corresponding to the degradation amount.

The controller 1440 may provide the power supply voltage level signal SVL indicating the final voltage level determined by the power supply voltage determiner 1448 to the scaler 1450. The scaler 1450 may control a power board in response to the power supply voltage level signal SVL such that the power supply voltage ELVDD has the final voltage level indicated by the power supply voltage level signal SVL. Accordingly, the voltage level of the power supply voltage ELVDD may be adjusted based on the luminance mode, based on the panel efficiency, and based on the degradation amount, and power consumption of the display device 1400 may be reduced.

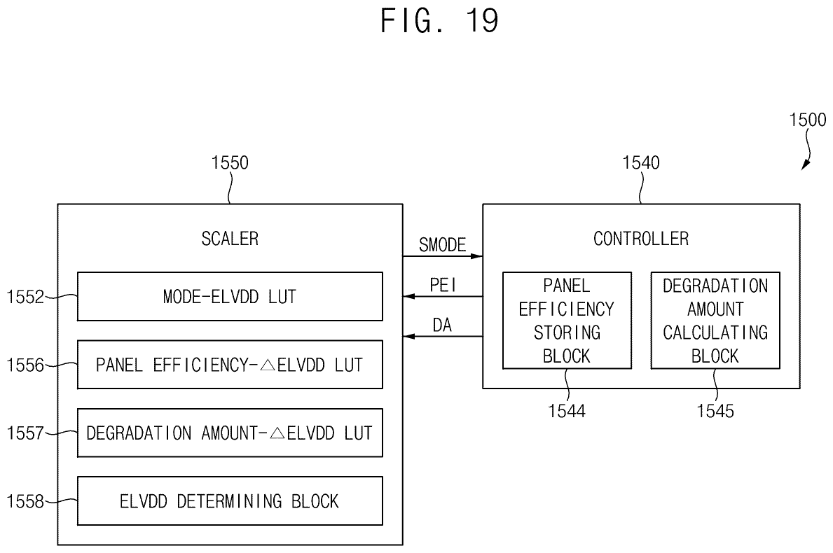

FIG. 19 is a block diagram illustrating a portion of a display device according to embodiments.

Referring to FIG. 19, a controller 1540 of a display device 1500 may include a panel efficiency bank (or panel-efficiency-storing block) 1544 and a degradation amount calculator (or degradation-amount-calculating block) 1545. To determine a power supply voltage ELVDD based on a luminance mode, based on a panel efficiency, and based on a degradation amount DA, a scaler 1550 of the display device 1500 may include a mode-to-power supply voltage (or mode-ELVDD, or mode-to-ELVDD) lookup table 1552, a panel efficiency-to-change amount (or panel efficiency-ΔELVDD, or panel efficiency-to-ΔELVDD) lookup table 1556, a degradation amount-to-change amount (or degradation amount-ΔELVDD, or degradation amount-to-ΔELVDD) lookup table 1557, and a power supply voltage determiner (e.g., ELVDD-determining block) 1558.

In some embodiments, the power supply voltage determiner 1558 may determine a first intermediate voltage level corresponding to the luminance mode by using the mode-to-power supply voltage lookup table 1552, may receive panel efficiency information PEI from the controller 1540, may receive a first power supply voltage level change amount corresponding to the panel efficiency indicated by the panel efficiency information PEI from the panel efficiency-to-change amount lookup table 1556, may determine a second intermediate voltage level by adjusting the first intermediate voltage level by the first power supply voltage level change amount corresponding to the panel efficiency, may receive the degradation amount DA from the controller 1540, may receive a second power supply voltage level change amount corresponding to the degradation amount DA from the degradation amount-to-change amount lookup table 1557, and may determine a final voltage level of the power supply voltage ELVDD by adjusting the second intermediate voltage level by the second power supply voltage level change amount corresponding to the degradation amount DA.

The scaler 1550 may control the power board such that the power supply voltage ELVDD has the final voltage level determined based on the luminance mode, based on the panel efficiency, and based the degradation amount DA. Accordingly, the voltage level of the power supply voltage ELVDD may be adjusted based on the luminance mode, the panel efficiency, and the degradation amount DA, and thus power consumption of the display device 1500 may be reduced.

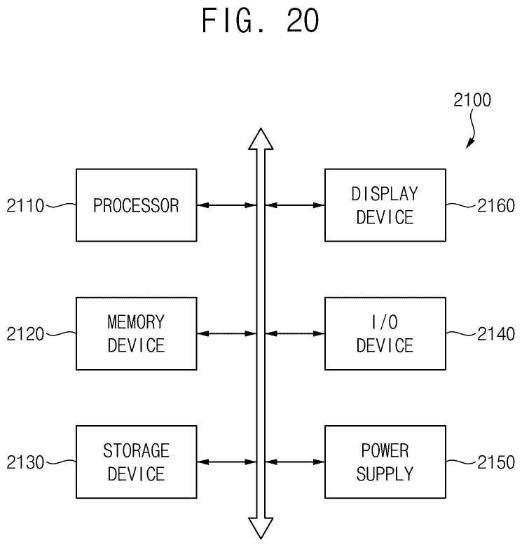

FIG. 20 is a block diagram illustrating an electronic device including a display device according to embodiments.

Referring to FIG. 20, an electronic device 2100 may include a processor 2110, a memory device 2120, a storage device 2130, an input/output (I/O) device 2140, a power supply 2150, and a display device 2160. The electronic device 2100 may further include a plurality of ports for communicating with a video card, a sound card, a memory card, a universal serial bus (“USB”) device, other electric devices, etc.

The processor 2110 may perform various computing functions or tasks. The processor 2110 may be an application processor (“AP”), a micro-processor, a central processing unit (“CPU”), etc. The processor 2110 may be coupled to other components via an address bus, a control bus, a data bus, etc. Further, in some embodiments, the processor 2110 may be further coupled to an extended bus, such as a peripheral component interconnection (“PCI”) bus.

The memory device 2120 may store data for operations of the electronic device 2100. For example, the memory device 2120 may include at least one non-volatile memory device, such as an erasable programmable read-only memory (“EPROM”) device, an electrically erasable programmable read-only memory (“EEPROM”) device, a flash memory device, a phase change random access memory (“PRAM”) device, a resistance random access memory (“RRAM”) device, a nano floating gate memory (“NFGM”) device, a polymer random access memory (“PoRAM”) device, a magnetic random access memory (“MRAM”) device, a ferroelectric random access memory (“FRAM”) device, etc., and/or at least one volatile memory device, such as a dynamic random access memory (“DRAM”) device, a static random access memory (“SRAM”) device, a mobile dynamic random access memory (“mobile DRAM”) device, etc.

The storage device 2130 may be a solid state drive (“SSD”) device, a hard disk drive (“HDD”) device, a compact disc-read only memory (“CD-ROM”) device, etc. The I/O device 2140 may be an input device, such as a keyboard, a keypad, a mouse, a touch screen, etc., and an output device, such as a printer, a speaker, etc. The power supply 2150 may supply power for operations of the electronic device 2100. The display device 2160 may be coupled to other components through the buses or other communication links.

In the display device 2160, a scaler may control a power board to adjust a power supply voltage for a plurality of pixels according to a luminance mode, a panel efficiency and/or a degradation amount of a display panel. Accordingly, in the display device 2160 in which the power board external to a control board directly provides the power supply voltage to the plurality of pixels, a voltage level of the power supply voltage may be adjusted, and power consumption of the display device 2160 may be reduced.

The disclosed embodiments may be applied to any electronic device 2100 including the display device 2160. For example, the disclosed embodiments may be applied to a mobile phone, a smart phone, a virtual reality (“VR”) device, a television (“TV”) (e.g., a digital TV, a three-dimensional (“3D”) TV, etc.), a wearable electronic device, a personal computer (“PC”) (e.g. a laptop computer, a tablet computer, etc.), a home appliance, a personal digital assistant (“PDA”), a portable multimedia player (“PMP”), a digital camera, a music player, a portable game console, a navigation device, etc.

The foregoing is illustrative of embodiments and is not to be construed as limiting thereof. Although a few embodiments have been described, those skilled in the art will readily appreciate that many modifications are possible in the embodiments without materially departing from the aspects of the present disclosure. Accordingly, all such modifications are intended to be included within the scope of the present disclosure as defined in the claims, with functional equivalents thereof to be included therein. Therefore, it is to be understood that the foregoing is illustrative of various embodiments and is not to be construed as limited to the specific embodiments disclosed, and that modifications to the disclosed embodiments, as well as other embodiments, are intended to be included within the scope of the appended claims.

What is claimed is:

1. A display device comprising:
a display panel comprising pixels;
a scan driver configured to provide scan signals to the pixels;
a data driver configured to provide data signals to the pixels;
a controller configured to control the scan driver and the data driver;
a power board configured to generate a power supply voltage for the pixels; and
a scaler configured to receive input image data from a host processor, to convert a data format of the input image data, to provide converted input image data to the controller, to determine a luminance mode of the display device, and to control the power board to adjust the power supply voltage according to the luminance mode.

2. The display device of claim 1, wherein a voltage level of the power supply voltage increases as a maximum luminance of the luminance mode increases.

3. The display device of claim 1, wherein the scaler comprises:
a mode-to-power supply voltage lookup table configured to store voltage levels of the power supply voltage respectively corresponding to luminance modes; and
a power supply voltage determiner configured to determine one of the voltage levels of the power supply voltage corresponding to the luminance mode using the mode-to-power supply voltage lookup table.

4. The display device of claim 1, wherein the controller comprises:
a mode-to-power supply voltage lookup table configured to store voltage levels of the power supply voltage respectively corresponding to luminance modes; and
a power supply voltage determiner configured to:
receive a mode signal indicating the luminance mode from the scaler; and
determine one of the voltage levels of the power supply voltage corresponding to the luminance mode using the mode-to-power supply voltage lookup table.

5. The display device of claim 4, wherein the controller is configured to provide a power supply voltage level signal indicating the one of the voltage levels of the power supply voltage to the scaler, and
wherein the scaler is configured to control the power board in response to the power supply voltage level signal such that the power supply voltage has the one of the voltage levels.

6. The display device of claim 1, wherein the power supply voltage is determined based on the luminance mode and a panel efficiency of the display panel.

7. The display device of claim 6, wherein a voltage level of the power supply voltage increases as a maximum luminance of the luminance mode increases, and decreases as the panel efficiency increases.

8. The display device of claim 6, wherein the controller comprises:
a mode-to-power supply voltage lookup table configured to store voltage levels of the power supply voltage respectively corresponding to luminance modes;
a panel efficiency bank configured to store panel efficiency information indicating the panel efficiency;
a panel efficiency-to-change amount lookup table configured to store power supply voltage level change amounts respectively corresponding to panel efficiencies; and
a power supply voltage determiner configured to:
receive a mode signal indicating the luminance mode from the scaler;
determine an intermediate voltage level of the power supply voltage corresponding to the luminance mode using the mode-to-power supply voltage lookup table;
receive the panel efficiency information from the panel efficiency bank;
receive one of the power supply voltage level change amounts corresponding to the panel efficiency information from the panel efficiency-to-change amount lookup table; and
determine a final voltage level of the power supply voltage by adjusting the intermediate voltage level by the one of the power supply voltage level change amounts.

9. The display device of claim 8, wherein the controller is configured to provide a power supply voltage level signal, which indicates the final voltage level, to the scaler, and
wherein the scaler is configured to control the power board in response to the power supply voltage level signal such that the power supply voltage has the final voltage level.

10. The display device of claim 6, wherein the controller comprises a panel efficiency bank configured to store panel efficiency information indicating the panel efficiency, and
wherein the scaler comprises:
a panel efficiency-to-change amount lookup table configured to store power supply voltage level change amounts respectively corresponding to panel efficiencies;
a mode-to-power supply voltage lookup table configured to store voltage levels of the power supply voltage respectively corresponding to luminance modes; and
a power supply voltage determiner configured to:
determine an intermediate voltage level of the power supply voltage corresponding to the luminance mode using the mode-to-power supply voltage lookup table;
receive the panel efficiency information from the controller;
receive a power supply voltage level change amount, which corresponds to the panel efficiency, from the panel efficiency-to-change amount lookup table; and
determine a final voltage level of the power supply voltage by adjusting the intermediate voltage level by the power supply voltage level change amount.

11. The display device of claim 1, wherein the power supply voltage is determined based on the luminance mode and a degradation amount of the display panel.

12. The display device of claim 11, wherein a voltage level of the power supply voltage increases as a maximum luminance of the luminance mode increases, or as the degradation amount increases.

13. The display device of claim 11, wherein the controller comprises:
a mode-to-power supply voltage lookup table configured to store voltage levels of the power supply voltage respectively corresponding to luminance modes;
a degradation amount calculator configured to calculate the degradation amount by accumulating the converted input image data received from the scaler;
a degradation amount-to-change amount lookup table configured to store power supply voltage level change amounts respectively corresponding to degradation amounts; and
a power supply voltage determiner configured to:
receive a mode signal, which indicates the luminance mode, from the scaler;
determine an intermediate voltage level of the power supply voltage corresponding to the luminance mode using the mode-to-power supply voltage lookup table;
receive the degradation amount from the degradation amount calculator;
receive a power supply voltage level change amount, which corresponds to the degradation amount, from the degradation amount-to-change amount lookup table; and
determine a final voltage level of the power supply voltage by adjusting the intermediate voltage level by the power supply voltage level change amount.

14. The display device of claim 13, wherein the controller is configured to provide a power supply voltage level signal, which indicates the final voltage level, to the scaler, and
wherein the scaler is configured to control the power board in response to the power supply voltage level signal such that the power supply voltage has the final voltage level.

15. The display device of claim 11, wherein the controller comprises:
a degradation amount calculator configured to calculate the degradation amount by accumulating the converted input image data received from the scaler, and
wherein the scaler comprises:
a mode-to-power supply voltage lookup table configured to store voltage levels of the power supply voltage respectively corresponding to luminance modes;
a degradation amount-to-change amount lookup table configured to store power supply voltage level change amounts respectively corresponding to degradation amounts; and
a power supply voltage determiner configured to:
determine an intermediate voltage level of the power supply voltage corresponding to the luminance mode using the mode-to-power supply voltage lookup table;
receive the degradation amount from the controller;
receive a power supply voltage level change amount, which corresponds to the degradation amount, from the degradation amount-to-change amount lookup table; and
determine a final voltage level of the power supply voltage by adjusting the intermediate voltage level by the power supply voltage level change amount.

16. The display device of claim 1, wherein the power supply voltage is determined based on the luminance mode, a panel efficiency of the display panel, and a degradation amount of the display panel.

17. A method of operating a display device, the method comprising:
determining, by a scaler of the display device, a luminance mode of the display device;
determining a power supply voltage according to the luminance mode;
generating, by a power board of the display device, the power supply voltage determined according to the luminance mode; and
displaying, by a display panel of the display device, an image based on the power supply voltage received from the power board.

18. The method of claim 17, wherein a voltage level of the power supply voltage increases as a maximum luminance of the luminance mode increases, and
wherein the method further comprises:
storing panel efficiency information indicating a panel efficiency of the display panel; and
adjusting a voltage level of the power supply voltage according to the panel efficiency.

19. The method of claim 17, further comprising:
calculating a degradation amount of the display panel; and
adjusting a voltage level of the power supply voltage according to the degradation amount.

20. An electronic device comprising a display device comprising:
a display panel comprising pixels;
a scan driver configured to provide scan signals to the pixels;
a data driver configured to provide data signals to the pixels;
a controller configured to control the scan driver and the data driver;
a power board configured to generate a power supply voltage for the pixels; and
a scaler configured to receive input image data from a host processor, to convert a data format of the input image data, to provide converted input image data to the controller, to determine a luminance mode of the display device, and to control the power board to adjust the power supply voltage according to the luminance mode.
